(19) United States
(12) Patent Application Publication
(10) Pub. No.: US 2023/0419152 A1
(43) Pub. Date: Dec. 28, 2023

(54) QUANTUM GATE GENERATION METHOD

(71) Applicant: BEIJING BAIDU NETCOM SCIENCE TECHNOLOGY CO., LTD., BEIJING (CN)

(72) Inventors: Jingbo WANG, BEIJING (CN); Yuao CHEN, BEIJING (CN)

(21) Appl. No.: 18/451,714

(22) Filed: Aug. 17, 2023

(30) Foreign Application Priority Data
Aug. 30, 2022 (CN) 202211057656.8

(51) Int. Cl. G06N 10/40; G06N 10/70

(52) U.S. Cl. CPC G06N 10/40; G06N 10/70

(57) ABSTRACT

A method is provided that includes: determining a plurality of ions for generating a quantum gate; in response to determining that the plurality of ions are located in at least two ion trap sections, performing an ion shuttle operation through an ion shuttle channel, such that the plurality of ions are all located in a first ion trap section of the at least two ion trap sections; and generating a quantum gate based on the plurality of ions in the first ion trap section after the ion shuttle operation. The first quantum gate is to be generated based on an ion trap chip. The ion trap chip includes a plurality of ion trap sections, each of the plurality of ion trap sections includes no more than a first number of ions, and the plurality of ion trap sections are coupled through ion shuttle channels.

### CROSS REFERENCE TO RELATED APPLICATIONS

The present application claims priority to Chinese Patent Application No. 202211057656.8 filed on Aug. 30, 2022, the contents of which is hereby incorporated by reference in its entirety for all purposes.

### TECHNICAL FIELD

The present disclosure relates to the field of quantum computers, and in particular, to the field of ion trap chip technologies, and for example, to a quantum gate generation method and apparatus, an electronic device, a computer-readable storage medium, and a computer program product.

### DESCRIPTION OF RELATED ART

In recent years, ion trap quantum computing has received extensive attention. As one of two major quantum computing platforms that keep pace with superconducting quantum computing, ion trap quantum computing has its own characteristics. In terms of connectivity, quantum gate fidelity, and qubit lifetime, ion traps are superior to the superconducting quantum platform. However, in terms of qubit scalability and quantum gate time, the capability of the ion trap quantum computing platform has process and design difficulties compared with that of the superconducting quantum computing platform.

### BRIEF SUMMARY

The present disclosure provides a quantum gate generation method and apparatus, an electronic device, a computer-readable storage medium, and a computer program product.

According to an aspect of the present disclosure, a quantum gate generation method is provided, the method includes: determining a plurality of ions for generating a first quantum gate based on an ion trap chip, wherein the ion trap chip comprises a plurality of ion trap sections each comprising no more than a first number of ions, and the plurality of ion trap sections are coupled through one or more ion shuttle channels, the first number being a positive integer greater than or equal to 2; in response to determining that the plurality of ions are located in at least two ion trap sections, performing an ion shuttle operation through the one or more ion shuttle channels, to make the plurality of ions are all located in a first ion trap section of the at least two ion trap sections; and after the ion shuttle operation, generating the first quantum gate based on the plurality of ions in the first ion trap section.

According to another aspect of the present disclosure, an electronic device is provided, including: a memory storing one or more programs configured to be executed by one or more processors, individually or collectively, the one or more programs including instructions for causing the electronic device to perform operations comprising: determining a plurality of ions for generating a first quantum gate based on an ion trap chip, wherein the ion trap chip comprises a plurality of ion trap sections each comprising no more than a first number of ions, and the plurality of ion trap sections are coupled through one or more ion shuttle channels, the first number being a positive integer greater than or equal to 2; in response to determining that the plurality of ions are located in at least two ion trap sections, performing an ion shuttle operation through the one or more ion shuttle channels, to make the plurality of ions are all located in a first ion trap section of the at least two ion trap sections; and after the ion shuttle operation, generating the first quantum gate based on the plurality of ions in the first ion trap section.

According to another aspect of the present disclosure, a non-transitory computer-readable storage medium storing one or more programs is provided, where the computer instructions, when executed by one or more processors of a computing device, are used to cause the computing device to implement acts comprising: determining a plurality of ions for generating a first quantum gate based on an ion trap chip, wherein the ion trap chip comprises a plurality of ion trap sections each comprising no more than a first number of ions, and the plurality of ion trap sections are coupled through one or more ion shuttle channels, the first number being a positive integer greater than or equal to 2; in response to determining that the plurality of ions are located in at least two ion trap sections, performing an ion shuttle operation through the one or more ion shuttle channels, to make the plurality of ions are all located in a first ion trap section of the at least two ion trap sections; and after the ion shuttle operation, generating the first quantum gate based on the plurality of ions in the first ion trap section.

It should be understood that the content described in this section is not intended to identify all features of embodiments of the present disclosure, and is not used to limit the scope of the present disclosure. Other features of the present disclosure will be easily understood through the g description herein.

### BRIEF DESCRIPTION OF THE DRAWINGS

The accompanying drawings show embodiments as examples and form a part of the specification, and are used to explain example implementations of embodiments together with a written description of the specification. The embodiments shown are merely for illustrative purposes and do not limit the scope of the claims. Throughout the accompanying drawings, the same reference numerals denote similar but not necessarily same elements.

FIG. 1 is a schematic diagram of a one-dimensional linear ion trap structure according to an embodiment of the present disclosure;

FIG. 2 is a schematic diagram of a shuttleable one-dimensional linear ion trap structure according to an embodiment of the present disclosure;

FIG. 3 is a schematic diagram of a two-dimensional linear ion trap structure according to an embodiment of the present disclosure;

FIG. 4 is a flowchart of a quantum gate generation method based on an ion trap chip according to an embodiment of the present disclosure;

FIG. 5 is a schematic diagram of two ion trap sections according to an embodiment of the present disclosure;

FIG. 6 is a schematic diagram of a quantum circuit to be implemented according to an embodiment of the present disclosure;

FIG. 7 to FIG. 11 are schematic diagrams of performing an ion shuttle operation based on the ion trap section shown in FIG. 5 according to an embodiment of the present disclosure;

FIG. 12 is a schematic diagram of a plurality of ion trap quantum chip configurations according to an embodiment of the present disclosure;

FIG. 13 is a schematic diagram of a comparison between fidelities and consumed times of different ion trap configurations in implementing a 24-bit 100-layer quantum circuit according to an embodiment of the present disclosure;

FIG. 14 is a structural block diagram of a quantum gate generation apparatus based on an ion trap chip according to an embodiment of the present disclosure; and

FIG. 15 is a structural block diagram of an example electronic device that can be used to implement an embodiment of the present disclosure.

### DETAILED DESCRIPTION OF EMBODIMENTS

Example embodiments of the present disclosure are described herein in conjunction with the accompanying drawings, where various details of embodiments of the present disclosure are included to facilitate understanding, and should only be considered as example. Therefore, those of ordinary skill in the art should be aware that various changes and modifications can be made to the embodiments described herein, without departing from the scope of the present disclosure. Likewise, for clarity and conciseness, the description of well-known functions and structures is omitted in the following description.

In the present disclosure, unless otherwise stated, the terms “first”, “second”, etc., used to describe various elements are not intended to limit the positional, temporal or importance relationship of these elements, but rather only to distinguish one component from another. In some examples, the first element and the second element may refer to the same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not for example defined, there may be one or more elements, unless otherwise expressly indicated in the context. Moreover, the term “and/or” used in the present disclosure encompasses any of and all possible combinations of listed items.

Illustrative embodiments of the present disclosure will be described below in detail with reference to the accompanying drawings.

So far, various types of computers in application all have used classical physics as a theoretical basis for information processing, and have been referred to as conventional computers or classical computers. Binary data bits that are easiest to implement physically are used by a classical information system to store data or programs. Each binary data bit is represented by 0 or 1 and referred to as a bit, and is the smallest information unit. The classical computers themselves have the inevitable disadvantages as follows: 1. most basic limitation from energy consumption in a computation process, in which minimum energy required by a logic element or a storage unit should be several times more than kT to avoid malfunction under thermal fluctuations; 2. information entropy and heating energy consumption; and 3. when a computer chip has a very high routing density, according to the Heisenberg's uncertainty principle, less uncertain electron positions indicate more uncertain momentum. When electrons are no longer confined, a quantum interference effect occurs. Such an effect may even damage performance of the chip.

Quantum computers are physical or virtual devices that follow the properties and laws of quantum mechanics to perform high-speed mathematical and logical computation, and store and process quantum information. Any device that processes and computes quantum information and runs a quantum algorithm is a quantum computer. The quantum computers follow the unique quantum dynamics law (especially quantum interference) to implement a new mode of information processing. For parallel processing of computing problems, the quantum computers have an absolute advantage over classical computers in speed. A transformation of each superposition component performed by the quantum computer is equivalent to a classical computation. All these classical computations are completed simultaneously and superposed based on a specific probability amplitude, and an output result of the quantum computer is provided. Such computing is referred to as quantum parallel computing. Quantum parallel processing greatly improves efficiency of the quantum computer, so that the quantum computer can complete operations that classical computers cannot complete, for example, factorization of a large natural number. Quantum coherence is utilized in all ultrafast quantum algorithms. Therefore, quantum parallel computing with quantum states replacing classical states can achieve an incomparable computation speed and an incomparable information processing function than the classical computers and also save a large amount of computation resources.

At present, hardware of quantum computers is still in the stage of noisy intermediate-scale quantum, and a superconducting platform basically can manufacture superconducting quantum chips of 100+ bits based on a micro-nano processing technology similar to conventional chip manufacturing. However, only the regulation effect of nearest-neighbor coupling exist between bits, and computing power of the quantum computer is affected by connectivity. In recent years, as one of potential general-purpose quantum computing hardware platforms in the future, ion trap quantum computing has developed rapidly and has achieved good results in both quantum gate fidelity and readout fidelity. For example, the single-bit gate fidelity can reach 99.99%, and the two-bit gate fidelity can reach 99.3%.

Due to the full connectivity feature, quantum computers based on ion trap chips can often achieve the same computing power as superconducting quantum computers at a smaller circuit depth. However, ion trap chips do not have corresponding conventional chip manufacturing methods and processes for guidance, and hit a bottleneck in scale expansion. At present, a number of qubits of quantum computers based on ion trap chips provided by mainstream ion trap hardware manufacturers is still less than 20. In the noisy intermediate-scale quantum computing era and future general-purpose quantum computing, 20 qubits are far from enough. How to design an effective solution to solve the problem of increasing a number of qubits of quantum computers based on ion trap chips has become an urgent and challenging problem.

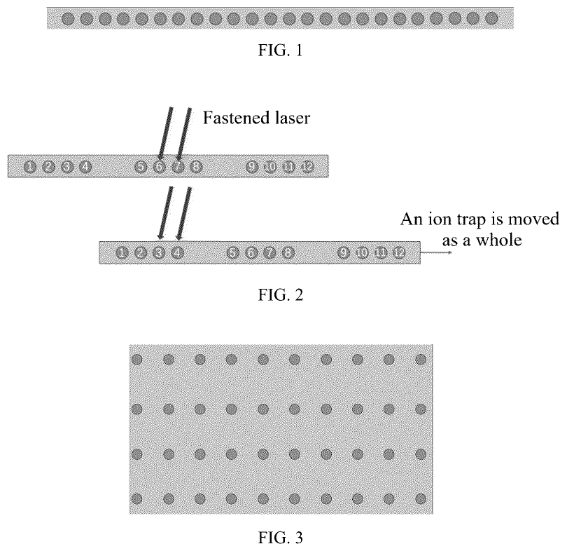

At present, mainstream ion trap hardware manufacturers in the industry have adopted the manufacturing structure of linear ion traps. For example, based on the arrangement of DC and AC electrodes, a quasi-one-dimensional electric potential field that can bind charged ions is formed in the space. Ions bound in a trap repel each other under the action of Coulomb force, so that a one-dimensional chain structure is naturally formed in the trap, e.g., an arrangement shown in FIG. 1 is presented. Each sphere represents an ion, that is, a qubit of a quantum computer based on an ion trap. Distances between ions may be equal or unequal depending on the difference in binding potential fields formed by electrodes. To perform a single-bit quantum gate operation through this quantum computer, two laser beams may be irradiated with specific parameters on a corresponding ion. However, if a two-bit quantum gate operation is to be performed, a plurality of laser beams may be irradiated on two corresponding ions. It is noted that ions are linked by long-range Coulomb interactions, in the one-dimensional linear ion trap structure described above, a two-bit gate can be implemented between any two ions.

At present, both 11-qubit ion trap quantum computers implemented by IonQ and 12-qubit ion trap quantum computers implemented by Honeywell in the industry adopt the one-dimensional linear ion trap structure described above. However, due to physical limitations of hardware devices, this solution generally cannot produce more qubits, a limited number of ions can be placed in a trap, and a maximum number of qubits thereof cannot exceed the square of a ratio of transverse/longitudinal bound potential frequencies (ωₜ/ωₗ) in a linear trap. In addition, due to the difficulty of ion addressing and vibration mode decoupling caused by the increase in a number of ions, a number of ions that can be accurately manipulated can only be kept at 20+, and cannot be increased to a larger number of bits.

To increase the number of bits of the ion trap quantum computer, some improvements can be made to the structure in FIG. 1. An method to increase the number of bits is that a plurality of ion traps are placed in a same chain trap, and during each operation, an ion trap is moved as a whole to move, to a region irradiated by laser beams, ions to be acted on, as shown in the FIG. 2. In the region irradiated by the laser beams, the moved ions are fully connected. However, the design of this solution is still limited to the one-dimensional linear ion trap structure, and its length limits a final upper limit of a number of qubits of a quantum computer, that is, limits the ability of this solution to be further expanded. Moreover, quantum tasks cannot be executed in parallel, and only calculation of ions can be performed each time in the region irradiated by laser beams. At the same time, due to the one-dimensional structure, on an ion trap chip structure of a same size, a number of ion bits carried by an ion trap chip of the one-dimensional structure is much smaller than that of an ion trap chip of a two-dimensional arrangement structure, and the increasing efficiency is low.

In addition, another method to increase the number of bits is that the spatial dimension is used to change the one-dimensional binding trap to a two-dimensional binding trap, as shown in FIG. 3. This allows ions to be arranged in a two-dimensional lattice in the trap, where each lattice point has an ion. In this way, the number of qubits that can be carried by a quantum computer is directly proportional to the region. In the ion trap that can only carry 10 qubits originally, 100 qubits can be placed in the two-dimensional ion trap structure. However, in this solution, a number of vibration modes of two-dimensional lattices formed by ions is also directly proportional to the region. To perform a high-precision operation on each ion, ions are decoupled from all lattice vibration modes. This cannot be implemented by a laser device in the current stage. Moreover, in the entire chip, a vibration mode of a two-dimensional lattice is complex, and it is difficult to decouple all lattice vibrations from ions based on the existing laser control technology. A depth of a quantum circuit that can be executed is small, the quantum gate fidelity is low, and a high-precision quantum computing task cannot be performed.

According to an embodiment of the present disclosure, a quantum gate generation method based on an ion trap chip is provided. The ion trap chip includes a plurality of ion trap sections, each of the plurality of ion trap sections includes no more than a first number of ions, and the plurality of ion trap sections are coupled through ion shuttle channels, where the first number is a positive integer greater than or equal to 2.

In an ion trap quantum control system, each ion in the ion trap represents a qubit, and two internal states |↓>, |↑> of the ion can be expressed as states |0>, |1> of the qubit. In the ion trap chip hardware platform according to the present disclosure, a plurality of ion trap sections are included. Each ion trap section can only carry a few ions, and the upper number limit is the first number, which is recorded as Ions more than the first number cannot be placed in the ion trap section.

As an example, for a two-bit quantum gate, no matter how far apart two ions are in a single ion trap section, a two-bit quantum gate operation can be performed, that is, qubits in a single ion trap section are fully connected. The two-bit quantum gate is still used as an example. The fidelity of the two-bit quantum gate is negatively correlated with the square of a number of ions in the current ion trap section, as shown in formula (1):

F=1 −ϵ_{gate}N² formula (1)

In addition, a quantum gate operation time τ_{gate} and a distance d(i,j) between two corresponding ions i,j is in a linear function relationship, as shown in formula (2):

τ_{gate}=α_{gate}+β_{gate}×d(i,j) formula (2)

ϵ_{gate}, α_{gate}, β_{gate} are all constants related to ion trap hardware, and can be easily determined by those skilled in the art and are not repeated herein.

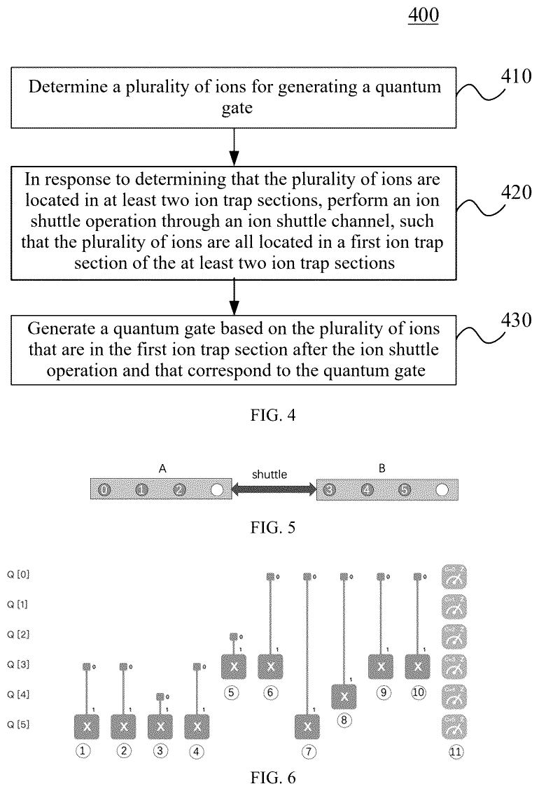

FIG. 4 is a flowchart 400 of a quantum gate generation method according to an embodiment of the present disclosure. As shown in FIG. 4, the method 400 includes: determining a plurality of ions for generating a quantum gate (step 410); in response to determining that the plurality of ions are located in at least two ion trap sections, performing an ion shuttle (shuttle) operation through an ion shuttle channel, such that the plurality of ions are all located in a first ion trap section of the at least two ion trap sections (step 420); and generating a quantum gate based on the plurality of ions that are in the first ion trap section after the ion shuttle operation and that correspond to the quantum gate (step 430).

According to embodiments of the present disclosure, in the ion trap quantum computing hardware platform, the ion trap is sectioned based on the characteristic that ions can freely shuttle in a narrow channel, each ion trap section is a separate ion trap, and a channel is added for ion shuttle between traps. While both connectivity and accuracy are considered, the number of qubits that can be used for quantum computing can be desirably increased, so that manufacturing a noisy intermediate-scale ion trap quantum computer on the ion trap quantum computing hardware platform becomes possible.

It can be understood that the ion shuttle channel for coupling between a plurality of ion traps (that is, ion trap sections) can be conveniently implemented based on the existing micro-processing technology. Ion traps and the shuttle channels therein can be implemented, for example, by laser-machined and metal-coated alumina sheets.

For example, when a quantum circuit task is input to the ion trap quantum computer, a qubit of a quantum circuit is mapped to each ion in the trap in a one-to-one correspondence. Then, as the quantum circuit runs downwards layer by layer, the ions can shuttle between different traps according to the needs of the circuit task, so that the ions in different traps can also perform a single-bit quantum gate or a multi-bit quantum gate in the circuit task.

According to some embodiments, after the ion shuttle operation, a number of ions in the second ion trap section is not less than a number of ions in the first ion trap. The second ion trap section includes another ion trap section of the at least two ion trap sections other than the first ion trap section. As mentioned above, the fidelity of the quantum gate to be generated is negatively correlated with the square of a number of ions in the current ion trap section. Therefore, fewer ions in the ion trap section indicates the higher fidelity of the generated quantum gate. Before the ion shuttle operation, the fidelity of the generated quantum gate can be improved by shuttling from a section including more ions to a section including fewer ions.

The two-bit quantum gate is still used as an example. If the two-bit quantum gate to be generated corresponds to ions located in different ion trap sections, for example, ion 1 is in section A and ion 2 is in section B, to perform a quantum gate operation between ion 1 and ion 2, ions in section A are shuttled to section B, or shuttle ions in section B to section A. Each ion shuttle operation reduces the overall fidelity of the quantum circuit, and the equivalent fidelity of the ion shuttle operation can be shown in formula (3):

Fₛₕᵤₜₜₗₑ=1−ϵₛₕᵤₜₜₗₑ×dₛ(i,j) formula (3)

An operation time of the ion shuttle operation can be expressed as formula (4):

τₛₕᵤₜₜₗₑ=βₛₕᵤₜₜₗₑ×dₛ(i,j) formula (4)

dₛ(i,j) is a distance between two sections, and ϵₛₕᵤₜₜₗₑ, βₛₕᵤₜₜₗₑ are all constants related to ion trap hardware, and can be easily determined by those skilled in the art and are not repeated herein.

In some examples, such as a two-bit quantum gate, before the ion shuttle operation, the first ion trap section may be an ion trap section that is included in at least two ion trap sections and whose ions do not reach the first number.

It should be noted that two-bit quantum gates can only be executed serially, for example, CX(Q[0],Q[1]) and CX(Q[2],Q[3]) can only be executed sequentially. CX indicates the two-bit quantum gate to be executed in the quantum circuit, Q indicates the qubit, and the number in [0]/[1] indicates a position of a qubit to be acted on. Two-bit quantum gates located in different ion traps (sections) can be executed in parallel, for example, if CX(Q[0],Q[1]) is in trap (section) A and CX(Q[2],Q[3]) is in trap (section) B, CX(Q[0],Q[1]) and CX(Q[2],Q[3]) can be performed simultaneously.

According to some embodiments, the quantum gate is a two-bit quantum gate, and before the ion shuttle operation, numbers of ions in the second ion trap section and the first ion trap section are equal, and a number of ions that are to be used to generate another quantum gate other than the two-bit quantum gate and that are in the first ion trap section is greater than a number of ions that are to be used to generate the another quantum gate and that are in the second ion trap section. The second ion trap section includes another ion trap section of the at least two ion trap sections other than the first ion trap section.

For example, for a two-bit quantum gate, the direction of ion shuttle can be performed according to the following manner: When ions for execution of a two-bit gate are located in two sections and a number of ions in section A is less than that of ions in section B, the ions in section B may be shuttled to section A. When numbers of ions are the same in the two sections, shuttle to a section including more non-executed two-bit quantum gates is selected. In this way, the higher fidelity of execution of the two-bit quantum gate in the same section can be ensured, and the number of shuttles can be reduced to improve the effect of circuit operation.

According to some embodiments, the method further includes: in response to that the quantum gate is a quantum gate of three or more bits, decomposing the quantum gate into a quantum gate set comprising at least one of a single-bit quantum gate and a two-bit quantum gate, to generate the quantum gate based on the quantum gate set and the ion trap chip.

For example, for a quantum gate of three or more bits, the quantum gate can be decomposed into a combination of single-bit quantum gates and/or two-bit quantum gates, and then the decomposed quantum gate is implemented based on the ion trap chip according to the ion shuttle operation of embodiments of the present disclosure.

According to some embodiments, before performing an ion shuttle operation through an ion shuttle channel, the method further includes: in response to determining that a position that is of an ion to be shuttled and that is in a corresponding ion trap section is not located at an end close to the ion shuttle channel, moving the ion to be shuttled to the end that is of the corresponding ion trap section and that is close to the ion shuttle channel.

In some examples, when the ions in section A are shuttled to section B, the shuttle operation needs to be performed from the end close to the ion shuttle channel in the section, and positions of ions in remaining positions need to be swapped with those of the ions at the end close to the ion shuttle channel in the same trap. The equivalent fidelity of the swap operation is shown in formula (5):

F_{swap}=1−ϵ_{swap}×d(i,j) formula (5)

A time of the swap operation is shown in formula (6):

τ_{swap}=β_{swap}×d(i,j) formula (6)

d(i,j) is a distance between ions in a same trap, and ϵ_{swap}, β_{swap} are all constants related to ion trap hardware, and can be easily determined by those skilled in the art and are not repeated herein.

According to some embodiments, before performing an ion shuttle operation through an ion shuttle channel, the method further includes: in response to determining that a position that is of an ion to be shuttled and that is in a corresponding ion trap section is not located at an end close to the ion shuttle channel, swapping, to an ion at the end close to the ion shuttle channel, quantum information of the ion to be shuttled, to use the ion at the end close to the ion shuttle channel as a new ion to be shuttled, to perform the ion shuttle operation. During the quantum gate operation, the quantum information can be swapped to a bit of the ion at the end, and then the ion at the end can be shuttled.

According to some embodiments, the method further includes: determining at least one of a fidelity and an operation time of the generated quantum gate based on the ion shuttle operation and the first ion trap section after the shuttle.

In some embodiments, the ion shuttle operation can be performed by driving corresponding physical devices, such as hardware devices based on lasers, SoC chips, timing controllers, and the like. In an example, a host uses an Ethernet connection to control the SoC chip and provide waveform data. After receiving a trigger command from the host, the SoC chip flows the stored data to a connected digital output module and DAC (digital-to-analog converter) through an SoC digital I/O pin, and the DAC converts a digital signal into a voltage waveform. Then, the ion shuttle operation is achieved by interfacing with a radio frequency waveform generator for laser pulse control.

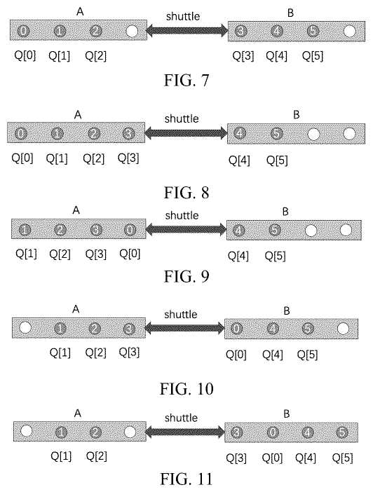

In some embodiments according to the present disclosure, in order to better illustrate the operation logic of the solution, a 6-qubit 10-layer quantum circuit task is used as an example for detailed description. According to the limitation of a hardware device (for example, the device only supports a maximum of 4 ions per trap), two ion trap sections as shown in FIG. 5 are constructed, and the two ion trap sections are coupled through the ion shuttle channel, where a number of white spheres represents remaining ions that can be accommodated in the section, and gray spheres represent ions already in the section. The 6-qubit circuit shown in FIG. 6 is generated by using quantum computing cloud platforms such as Quantum Leaf. Qubits in the quantum circuit are mapped to section A and section B respectively. As shown in FIG. 7, qubits Q[0] to Q[2] are mapped to three ions in section A, and qubits Q[3] to Q[5] are mapped to three ions in section B.

According to the quantum circuit shown in FIG. 6, it is sequentially determined whether ions corresponding to the two-bit quantum gate to be generated are in a same section, and if yes, the quantum gate operation can be performed directly. For example, the ions corresponding to the two-bit quantum gates \textcircled{1}\textcircled{2}\textcircled{3}\textcircled{4} are all in section B, and can be executed sequentially. The fidelity of each quantum gate is: F₁=F₂=F₃=F₄=(1−ϵ_{gate}×3²). A quantum gate operation time is determined according to a distance between ions, and can be expressed as: τ₁=τ₂=τ₄=(α_{gate}+β_{gate}×2), τ3=(α_{gate}+β_{gate}×1).

In execution of a quantum gate \textcircled{5}, because the qubit Q[0] is in section A and ions corresponding to qubit Q[3] are in section B, firstly Q[3] is shuttled into section A, as shown in FIG. 8. The fidelity for performing an ion shuttle operation can be expressed as: F_{shuttle,1}=βₛₕᵤₜₜₗₑ×1), and the operation time of the ion shuttle operation is: τ_{shuttle,1}=βₛₕᵤₜₜₗₑ×1. Because the number of ions in section A becomes 4, the fidelity for executing the quantum gate \textcircled{5} is: F₅=(1 −ϵ_{gate}×4²), and the quantum gate operation time is: τ₅=(α_{gate}+β_{gate}×1).

In execution of a quantum gate \textcircled{6}, because the corresponding ions Q[0] and Q[3] are already in the same section in the previous operation, the ion shuttle operation is no longer needed, and therefore the fidelity of the quantum gate and the quantum gate operation time can be respectively expressed as: F₆=(1 −ϵ_{gate}×4²). τ₆=(α_{gate}+β_{gate}×3).

In execution of a quantum gate ED, because the ions corresponding to qubits Q[0] and Q[5] are in different sections, the number of ions in section A is already saturated, and section B can carry two additional ions, the ions corresponding to Q[0] in section A can only be shuttled to section B. Because Q[0] is at the other end, Q[0] needs to be swapped to the position of Q[3] before the ion shuttle operation can be performed. As shown in FIG. 9, the time for the swap operation is: τ_{swap,1}=β_{swao}×3, and the fidelity of the swap operation is: F_{swap,1}=1−ϵ_{swap}×3. After ion 0 is swapped to the end adjacent to section B, the ion shuttle operation can be performed so that Q[0] is shuttled to section B, as shown in FIG. 10. The fidelity of the ion shuttle operation is: F_{shuttle,2}=(1−ϵₛₕᵤₜₜₗₑ×1), and the time of the ion shuttle operation is: τ_{shuttle,2}=βₛₕᵤₜₜₗₑ×1. The fidelity and the time for executing quantum gate \textcircled{7} are respectively: F₇=(1−ϵ_{gate}×3²). τ₇=(α_{gate}+β_{gate}×2).

In execution of a quantum gate \textcircled{8}, because the corresponding ions Q[0] and Q[4] are already in the same section in the previous operation, the fidelity and the time for executing the quantum gate \textcircled{8} are respectively: F_{S}=(1−ϵ_{gate}×3²), τ₇=(α_{gate}+β_{gate}×1).

In execution of quantum gates \textcircled{9} and \textcircled{10}, ion 3 in section A can be shuttled to section B, as shown in FIG. 11. The fidelity of the ion shuttle operation is: F_{shuttle,3}=(1−ϵₛₕᵤₜₜₗₑ×1), and the time of the ion shuttle operation is: τ_{shuttle,3}=βₛₕᵤₜₜₗₑ×1. After the shuttle is completed, the two qubits Q[0] and Q[3] are in the same section, and the two-bit quantum gate can be directly executed. The fidelity and the time for executing quantum gates \textcircled{9} and \textcircled{10} are respectively: F₉=F₁₀=(1−ϵ_{gate}×4²). T₉=τ₁₀=(α_{gate}+β_{gate}×1).

Finally, measurements can be performed on all qubits to obtain results for the quantum circuit. The total fidelity for executing the quantum circuit can be expressed as: Fₜₒₜₐₗ [symbol] , and the total execution time can be expressed as: Tₜₒₜₐₗ= [symbol] .

It can be understood that, in addition to the two-bit quantum gate, the method according to some embodiments of the present disclosure is also applicable to a three-bit quantum gate, a four-bit quantum gate, etc., which will not be repeated herein.

In some embodiments according to the present disclosure, ions are placed in different ion trap sections, and a shuttle channel that can transfer ions is added between the sections. Although the ion shuttle between a plurality of sections reduces the fidelity to some extent, this can effectively improve the success rate of ion trap quantum hardware execution, and can also improve the total number of qubits in the ion trap quantum platform.

In order to verify the effectiveness of the solution on larger-scale ion trap qubits, a random quantum circuit with 24 qubits and a circuit depth of 100 layers is selected for comparison. For hardware device parameters, refer to precision that can be recently achieved in the laboratory, as shown in Table 1.

TABLE 1

| Gate | two-bit | Shuttle | Shuttle | Swap | Swap |
|---|---|---|---|---|---|
| fidelity | quantum | fidelity | time | fidelity | operation |
| loss | gate time | loss | coefficient | loss | time |
| coefficient | (unit: μs) | coefficient | (unit: μs) | coefficient | (unit: μs) |
| ϵ_{gate} = 10⁻⁴ | α_{gate} = 20 | ϵₛₕᵤₜₜₗₑ = 10⁻² | β_{gate} = 50 | ϵ_{swap} = 10⁻² | β_{swap} = 20 |
| | β_{gate} = 10 | | | | |

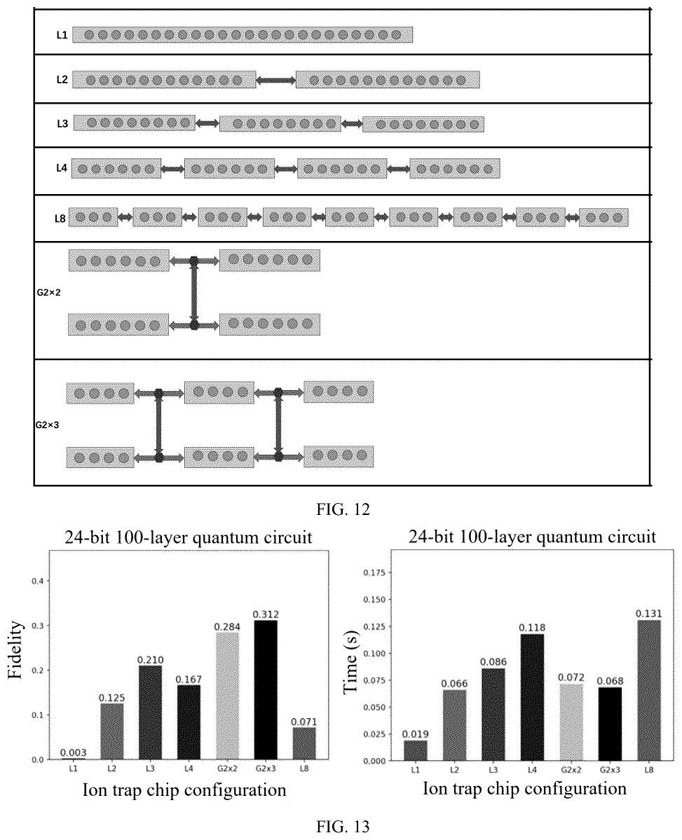

For a 24-ion trap qubit circuit, seven different ion trap quantum chip configurations are constructed, where L1 is the current one-dimensional linear trap structure. The description of the ion trap quantum chip configuration is shown in Table 2 and FIG. 12, where each double-headed arrow in FIG. 12 is a shuttle channel, and shuttle channels are connected by polygonal points.

TABLE 2

| L1 | L2 | L3 | L4 | L8 | G2 × 2 | G2 × 3 |
|---|---|---|---|---|---|---|
| 24 ions are | 12 ions per | 8 ions per | 6 ions per | 3 bits per | 6 ions per | 4 ion traps |
| in the same | trap, a total | trap, three | trap, four | trap, eight | trap, four | per trap, |
| linear trap, | of two trap | traps are | traps are | traps are | traps are | six traps |
| which is a | arrangeme | arranged in | arranged | arranged | arranged | are in a |
| common | nts | series | in series | in series | in a 2 × 2 | 2 × 3 |
| solution in | | | | | square | arrangement |
| the | | | | | array | |
| industry. | | | | | | |

FIG. 13 is a schematic diagram of comparing fidelities and consumed times of different ion trap configurations in implementing a 24-bit 100-layer quantum circuit according to an embodiment of the present disclosure. As shown in FIG. 13, it can be seen that in the selected random circuit, when the G2×3 configuration ion trap constructed according to some embodiments of the present disclosure operates a 24-qubit 100-layer circuit, although its time consumption is 0.068/0.019=3.6 times of a common one-dimensional linear ion trap L1, the fidelity of the obtained quantum circuit is 0.312/0.003=104 times that of the common linear ion trap. That is, under the same fidelity, the method according to some embodiments of the present disclosure can support more qubits. On a 48-qubit 100-layer random quantum circuit, the fidelity of the ion trap of the G2×3 configuration constructed according to some embodiments of the present disclosure can also be close to 0.2, and the effect is far better than that of a common linear ion trap construction method.

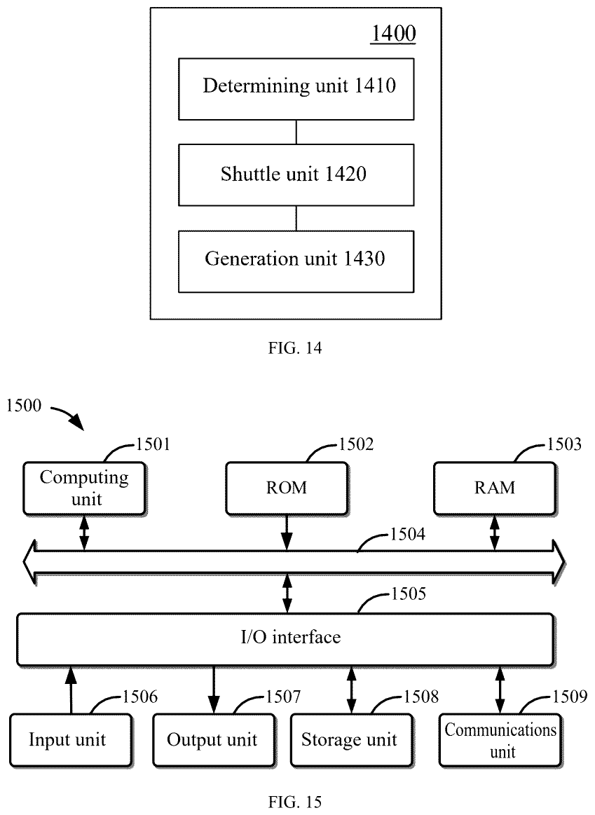

According to some embodiment of the present disclosure, as shown in FIG. 14, a quantum gate generation apparatus 1400 based on an ion trap chip is further provided. The ion trap chip includes a plurality of ion trap sections, each of the plurality of ion trap sections includes no more than a first number of ions, and the plurality of ion trap sections are coupled through ion shuttle channels, where the first number is a positive integer greater than or equal to 2. The apparatus 1400 includes: a determining unit 1410, configured to determine a plurality of ions for generating a quantum gate; a shuttle unit 1420, configured to: in response to determining that the plurality of ions are located in at least two ion trap sections, perform an ion shuttle operation through an ion shuttle channel, such that the plurality of ions are all located in a first ion trap section of the at least two ion trap sections; and a generation unit 1430, configured to generate a quantum gate based on the plurality of ions that are in the first ion trap section after the ion shuttle operation and that correspond to the quantum gate.

Herein, the operations of the foregoing units 1410 to 1430 of the quantum gate generation apparatus 1400 based on an ion trap chip are respectively similar to the operations in steps 410 to 430 described above. Details are not provided herein again.

According to the embodiments of the present disclosure, an electronic device, a readable storage medium, and a computer program product are further provided.

Referring to FIG. 15, a structural block diagram of an electronic device 1500 that may serve as a server or a client of the present disclosure is now described, which is an example of a hardware device that may be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 15, the electronic device 1500 includes a computing unit 1501. The computing unit may perform various appropriate actions and processing according to a computer program stored in a read-only memory (ROM) 1502 or a computer program loaded from a storage unit 1508 to a random access memory (RAM) 1503. The RAM 1503 may further store various programs and data required for the operation of the electronic device 1500. The computing unit 1501, the ROM 1502, and the RAM 1503 are connected to each other through a bus 1504. An input/output (I/O) interface 1505 is also connected to the bus 1504.

A plurality of components in the electronic device 1500 are connected to the I/O interface 1505, including: an input unit 1506, an output unit 1507, the storage unit 1508, and a communications unit 1509. The input unit 1506 may be any category of device capable of entering information to the electronic device 1500. The input unit 1506 may receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 1507 may be any category of device capable of presenting information, and may include, but is not limited to, a display, a speaker, a video/audio output terminal, a vibrator, and/or a printer. The storage unit 1508 may include, but is not limited to, a magnetic disk and an optical disk. The communications unit 1509 allows the electronic device 1500 to exchange information/data with other devices through a computer network such as the Internet and/or various telecommunications networks, and may include, but is not limited to, a modem, a network interface card, an infrared communications device, a wireless communications transceiver, and/or a chipset, for example, a Bluetooth™ device, an 802.11 device, a WiFi device, a WiMax device, or a cellular communications device and/or similar devices.

The computing unit 1501 may be various general-purpose and/or special-purpose processing components with processing and computing power. Some examples of the computing unit 1501 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 1501 performs the various methods and processing described above, for example, the method 400. For example, in some embodiments, the method 400 may be implemented as a computer software program, which is tangibly contained in a machine-readable medium, such as the storage unit 1508. In some embodiments, a part or all of the computer program may be loaded and/or installed onto the electronic device 1500 through the ROM 1502 and/or the communications unit 1509. When the computer program is loaded onto the RAM 1503 and executed by the computing unit 1501, one or more steps of the method 400 described above may be performed. Alternatively, in other embodiments, the computing unit 1501 may be configured in any other suitable manner (for example, by means of firmware), to perform the method 400.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: The systems and technologies are implemented in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other categories of apparatuses can also be used to provide interaction with the user; for example, feedback provided to the user can be any form of sensory feedback (for example, visual feedback, auditory feedback, or tactile feedback), and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), the Internet, and a blockchain network.

A computer system may include a client and a server. The client and the server are generally far away from each other and usually interact through a communications network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

Although embodiments or examples of the present disclosure have been described with reference to the accompanying drawings, it should be appreciated that the method, system, and device described above are merely example embodiments or examples, and the scope of the present disclosure is not limited by the illustrated embodiments or examples, and the equivalent scope thereof. Various elements in embodiments or examples may be omitted or substituted by equivalent elements thereof. Moreover, the steps may be performed in an order different from that described in the present disclosure. Further, various elements in embodiments or examples may be combined in various ways. It is important that, as the technology evolves, many elements described herein may be replaced with equivalent elements that appear after the present disclosure.

What is claimed is:

1. A computer-implemented method, comprising:
determining a plurality of ions for generating a first quantum gate based on an ion trap chip, wherein the ion trap chip comprises a plurality of ion trap sections each comprising no more than a first number of ions, and the plurality of ion trap sections are coupled through one or more ion shuttle channels, the first number being a positive integer greater than or equal to 2;
in response to determining that the plurality of ions are located in at least two ion trap sections, performing an ion shuttle operation through the one or more ion shuttle channels, to make the plurality of ions are all located in a first ion trap section of the at least two ion trap sections; and
after the ion shuttle operation, generating the first quantum gate based on the plurality of ions in the first ion trap section.

2. The method according to claim 1, wherein after the ion shuttle operation, a number of ions in a second ion trap section of the at least two ion trap sections is not less than the number of ions in the first ion trap section;
wherein the second ion trap section is different from the first ion trap section.

3. The method according to claim 1, wherein the first quantum gate is a two-bit quantum gate, and wherein before the ion shuttle operation, a number of ions in a second ion trap section of the at least two ion trap sections and a number of ions in the first ion trap section are equal, and wherein a first number of ions in the first ion trap section that are to be used to generate a second quantum gate other than the first quantum gate is greater than the second number of ions in the second ion trap section that are to be used to generate the second quantum gate,
wherein the second ion trap section is different from the first ion trap section.

4. The method according to claim 1, further comprising: in response to that an intermediary first quantum gate is a quantum gate of three or more bits, decomposing the intermediary first quantum gate into a quantum gate set comprising at least one of a single-bit quantum gate and a two-bit quantum gate, to generate the first quantum gate based on the quantum gate set and the ion trap chip.

5. The method according to claim 1, further comprising:
before the performing the ion shuttle operation through an ion shuttle channel, and in response to determining that a position of an ion to be shuttled in a corresponding ion trap section is not located at an end adjacent to the ion shuttle channel, moving the ion to be shuttled in the corresponding ion trap section to the end adjacent to the ion shuttle channel.

6. The method according to claim 1, further comprising:
before the performing the ion shuttle operation through the ion shuttle channel, and in response to determining that a position of an ion to be shuttled in a corresponding ion trap section is not located at an end adjacent to the ion shuttle channel, swapping, quantum information of the ion to be shuttled, to an ion at the end adjacent to the ion shuttle channel, to use the ion at the end adjacent to the ion shuttle channel as a new ion to be shuttled to perform the ion shuttle operation.

7. The method according to claim 1, further comprising: determining at least one of a fidelity and an operation time of the generated first quantum gate based on the ion shuttle operation and the first ion trap section after the ion shuttle operation.

8. An electronic device, the electronic device comprising:
a memory storing one or more programs configured to be executed by one or more processors, individually or collectively, the one or more programs including instructions for causing the electronic device to perform operations comprising:
determining a plurality of ions for generating a first quantum gate based on an ion trap chip, wherein the ion trap chip comprises a plurality of ion trap sections each comprising no more than a first number of ions, and the plurality of ion trap sections are coupled through one or more ion shuttle channels, the first number being a positive integer greater than or equal to 2;
in response to determining that the plurality of ions are located in at least two ion trap sections, performing an ion shuttle operation through the one or more ion shuttle channels, to make the plurality of ions are all located in a first ion trap section of the at least two ion trap sections; and
after the ion shuttle operation, generating the first quantum gate based on the plurality of ions in the first ion trap section.

9. The electronic device according to claim 8, wherein after the ion shuttle operation, a number of ions in a second ion trap section of the at least two ion trap sections is not less than the number of ions in the first ion trap section;
wherein the second ion trap section is different from the first ion trap section.

10. The electronic device according to claim 8,
wherein the first quantum gate is a two-bit quantum gate, and wherein before the ion shuttle operation, a number of ions in a second ion trap section of the at least two ion trap sections and a number of ions in the first ion trap section are equal, and wherein a first number of ions in the first ion trap section that are to be used generate a second quantum gate other than the first quantum gate is greater than a second number of ions in the second ion trap section that are to be used to generate the second quantum gate,
wherein the second ion trap section is different from the first ion trap section.

11. The electronic device according to claim 8, the operations further comprising: in response to that an intermediary first quantum gate is a quantum gate of three or more bits, decomposing the intermediary first quantum gate into a quantum gate set comprising at least one of a single-bit quantum gate and a two-bit quantum gate, to generate the first quantum gate based on the quantum gate set and the ion trap chip.

12. The electronic device according to claim 8, the operations further comprising:
before the performing the ion shuttle operation through an ion shuttle channel, and in response to determining that a position of an ion to be shuttled in a corresponding ion trap section is not located at an end adjacent to the ion shuttle channel, moving the ion to be shuttled in the corresponding ion trap section to the end adjacent to the ion shuttle channel.

13. The electronic device according to claim 8, the operations further comprising:
before the performing the ion shuttle operation through the ion shuttle channel, and in response to determining that a position of an ion to be shuttled in a corresponding ion trap section is not located at an end adjacent to the ion shuttle channel, swapping, quantum information of the ion to be shuttled, to an ion at the end adjacent to the ion shuttle channel, to use the ion at the end adjacent to the ion shuttle channel as a new ion to be shuttled to perform the ion shuttle operation.

14. The electronic device according to claim 8, the operations further comprising: determining at least one of a fidelity and an operation time of the generated first quantum gate based on the ion shuttle operation and the first ion trap section after the ion shuttle operation.

15. A non-transitory computer-readable storage medium that stores one or more programs comprising instructions that, when executed by one or more processors of a computing device, individually or collectively, cause the computing device to implement acts comprising:
determining a plurality of ions for generating a first quantum gate based on an ion trap chip, wherein the ion trap chip comprises a plurality of ion trap sections each comprising no more than a first number of ions, and the plurality of ion trap sections are coupled through one or more ion shuttle channels, the first number being a positive integer greater than or equal to 2;
in response to determining that the plurality of ions are located in at least two ion trap sections, performing an ion shuttle operation through the one or more ion shuttle channels, to make the plurality of ions are all located in a first ion trap section of the at least two ion trap sections; and
after the ion shuttle operation, generating the first quantum gate based on the plurality of ions in the first ion trap section.

16. The non-transitory computer-readable storage medium according to claim 15, wherein after the ion shuttle operation, a number of ions in a second ion trap section of the at least two ion trap sections is not less than the number of ions in the first ion trap section;
wherein the second ion trap section is different from the first ion trap section.

17. The non-transitory computer-readable storage medium according to claim 15, wherein the first quantum gate is a two-bit quantum gate, and wherein before the ion shuttle operation, a number of ions in a second ion trap section of the at least two ion trap sections and a number of ions in the first ion trap section are equal, and wherein a first number of ions in the first ion trap section that are to be used to generate a second quantum gate other than the first quantum gate is greater than a second number of ions in the second ion trap section that are to be used to generate the second quantum gate,
wherein the second ion trap section is different from the first ion trap section.

18. The non-transitory computer-readable storage medium according to claim 15, the acts further comprising: in response to that an intermediary first quantum gate is a quantum gate of three or more bits, decomposing the intermediary first quantum gate into a quantum gate set comprising at least one of a single-bit quantum gate and a two-bit quantum gate, to generate the first quantum gate based on the quantum gate set and the ion trap chip.

19. The non-transitory computer-readable storage medium according to claim 15, the acts further comprising:
before the performing the ion shuttle operation through an ion shuttle channel, and in response to determining that a position of an ion to be shuttled in a corresponding ion trap section is not located at an end adjacent to the ion shuttle channel, moving the ion to be shuttled in the corresponding ion trap section to the end adjacent to the ion shuttle channel.

20. The non-transitory computer-readable storage medium according to claim 15, the acts further comprising:
before the performing the ion shuttle operation through the ion shuttle channel, and in response to determining that a position of an ion to be shuttled in a corresponding ion trap section is not located at an end adjacent to the ion shuttle channel, swapping, quantum information of the ion to be shuttled, to an ion at the end adjacent to the ion shuttle channel, to use the ion at the end adjacent to the ion shuttle channel as a new ion to be shuttled to perform the ion shuttle operation.
